(19) United States
(12) Patent Application Publication
(10) Pub. No.: US 2006/0086557 A1
(43) Pub. Date: Apr. 27, 2006

(54) Inherently failsafe electric power steering system

(76) Inventor: Edward H. Phillips, Troy, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/258,607

(22) Filed: Oct. 25, 2005

Related U.S. Application Data
(60) Provisional application No. 60/621,797, filed on Oct. 25, 2004.

(51) Int. Cl. B62D 5/08

(52) U.S. Cl. 180/441

(57) ABSTRACT

An electronically controlled hydro-mechanically coupled power steering system includes a double-acting power cylinder having a directional control under-lapped four-way open center valve and a motor driven pump. A controller selectively provides pressurized fluid to the double-acting power cylinder to function in the manner of an inherently failsafe EPS system.

This application claims priority to U.S. Provisional Application Ser. No. 60/621,797 filed Oct. 25, 2004.

### BACKGROUND OF THE INVENTION

The present invention relates generally to power steering systems for vehicles, and more particularly to hydro-mechanically coupled electrically powered steering systems.

Currently it is anticipated that an overwhelming majority of vehicular power steering systems will be electrically powered in the future. Most common will be electric power steering systems (hereinafter “EPS systems”) wherein motors directly deliver steering force as a function of current applied to them by a controller. Because such motors directly deliver steering force, all EPS systems must have an absolute failsafe shutdown mode that unfailingly causes the system to revert to manual steering in the event of any sub-system failure. Such shutdown modes must at a minimum deactivate the system motor.

On the other hand, electro-hydraulic power steering systems (hereinafter “EHPS systems”) utilize a surplus of pressurized fluid flowing through a driver controlled open-center four-way valve to control operation of a system power cylinder (e.g., similarly to present engine pump driven hydraulic power steering systems but in this case with the pressurized fluid provided by an electric motor driven pump). Since a driver directly controls steering motion in a vehicle equipped with an EHPS system, they are inherently failsafe in operation. EHPS systems are not considered acceptable for utilization in future vehicles however, because they waste a significant percentage of the pressurized fluid in all but “accident avoidance” maneuvers in order to effect differential output pressure control. Thus they are in general not capable of being utilized for vehicles with larger steering loads, such as for instance, typical medium sized automobiles. Thus as defined herein, an EPS system is one wherein a motor directly delivers steering force whenever providing steering assist, while in an EHPS system steering force is generated by an open-center valve selectively metering a continuous flow of pressurized fluid there through in order to generate differential pressure across a power cylinder.

A particularly desirable hydro-mechanically coupled EPS system is described in U.S. Pat. No. 6,152,254, entitled “Feedback and Servo Control for Electric Power Steering System with Hydraulic Transmission,” issued Nov. 28, 2000 to Edward H. Phillips. Because of continued reference to the '254 patent hereinbelow, the whole of that patent is expressly incorporated in its entirety by reference herein. In that system, differential pressure is directly delivered to a double-acting power cylinder from a motor driven pump, whereby it is differentiated from an EHPS system in accordance with the above definition in that all of the pumped pressurized fluid is directly applied to assisted steering of a host vehicle. In any case, one of that EPS system's most desirable features is that in addition to deactivating the system motor when activating a shutdown mode as called for above, both ports of its system power cylinder are faulted to each other and a system reservoir in the event of any sub-system failure as redundant shutdown mode measure.

In all presently known EPS systems however (e.g., even including the hydro-mechanically coupled EPS system described in the incorporated '254 patent), all shutdown modes are software controlled and electronically implemented whereby there exists a finite possibility that all such shutdown modes could simultaneously fail and that a resulting runaway steering event could occur. This possibility is exacerbated by the fact that apparatus supporting these safety shutdown modes must survive indefinitely through changes of vehicle ownership, indifferent maintenance scenarios, and even tinkering by unqualified individuals.

Further and similarly to all other known EPS systems, the hydro-mechanically coupled EPS system described in the incorporated '254 patent has the undesirable characteristic of reflecting motor inertia back to the vehicle's steering wheel whenever negligible power assist is required such as during on-center operation and/or at very high vehicular speeds. This is especially bothersome because the motor inertia is compliantly coupled to the steering wheel (i.e., via a torsion bar).

### SUMMARY OF THE INVENTION

A hydro-mechanically coupled EPS system according to the present invention functions in an inherently failsafe manner and avoids reflecting motor inertia back to the vehicle's steering wheel whenever negligible power assist is required.

The hydro-mechanically coupled EPS system (which, again is differentiated from an EHPS system because in accordance with the above definition its motor directly delivers steering force whenever providing steering assist) includes a double-acting power cylinder having left and right cylinder ports and a directional control valve. The directional control valve is preferably an under-lapped four-way valve and has an input port, a return port fluidly connected to a reservoir and left and right output ports respectively fluidly connected to the left and right cylinder ports. Pressurized fluid can be delivered to either of the left and right cylinder ports during transition by the directional control valve through and beyond its underlap region. An electronically controlled motor driven pump has an output port fluidly connected to the input port of the directional control valve.

The hydro-mechanically coupled EPS system further includes a steering wheel torque transducer for providing an applied torque signal Vₐₜ indicative of values of torque applied to the steering wheel (hereinafter optionally “applied torque”). An optional pressure transducer provides a pressure signal Vₚ indicative of pressure values present at the input port of the directional control valve. A controller provides a power control signal Vₑ to the motor driven pump based upon the difference between a control function signal V_{cf} determined by a control algorithm from at least the magnitude of the applied torque signal Vₐₜ and the pressure signal Vₚ issued by the pressure transducer. The motor driven pump is controlled such that pressurized fluid is supplied to the input port of the directional control valve at fluid pressure values that continually move toward the control function signal V_{cf}.

In the case of a system not utilizing the optional pressure transducer, the controller provides a power control signal V_{c} to the motor driven pump at values of the power control signal V_{c} determined directly from the control function signal V_{cf}. Thus in either case, pressurized fluid is provided by the directional control valve to one of the ports of the double-acting power cylinder as determined by the rotational direction of the applied torque at a value in accordance with the magnitude of the applied torque and the resulting control algorithm determined control function signal V_{cf}.

It is desirable to decouple the motor inertia from the steering wheel during “on-center” steering conditions. This is accomplished by fluidly coupling both of the left and right cylinder ports to the reservoir during on-center operation. This is realized by fluid freely flowing through the orifices of the directional control valve when in a true centered position and progressively otherwise by virtue of either one of the left and right output ports of the directional control valve being predominately fluidly connected to the reservoir via a check valve and its input port, and the other one being predominately fluidly connected to the reservoir by its return port depending upon the direction of the torque applied to the steering wheel. Of course, this mode of operation requires that the directional control valve transition through its underlap region (e.g., the various control orifices there within achieve fully closed status) at relatively low values of applied torque (i.e., ±10 in.lbs.) and that the control algorithm is configured such that the control function constant K_{cf} has substantially zero values for lesser values of applied torque.

Inherently failsafe operation of the hydro-mechanically coupled EPS system is provided by the directional control valve directly controlling fluid flow to the ports of the double-acting power cylinder in the manner of present engine pump driven hydraulic power steering systems. Directional control of pressurized fluid applied to the double-acting power cylinder is manually implemented by driver control of the directional control under-lapped four-way valve via the steering wheel and a steering shaft connected thereto.

A method for enabling a hydro-mechanically coupled power steering system includes the step of fluidly connecting the input port of the pump to the reservoir and fluidly connecting the output port of the pump to the input port of the directional control valve. The pressure transducer is connected to the input port of the directional control valve. The return port of the directional control valve is connected to the reservoir. Torque applied to the steering wheel is measured and a signal representative of the magnitude of the applied torque is provided. A signal representative of a desired pressure value to be applied to the input port of the directional control valve is determined as a selected function of at least the magnitude of the applied torque. The pressure value actually present at the input port of the directional control valve is measured and subtracted from the desired instant pressure value to form an error signal. The error signal is filtered and amplified to form a power control signal and the pump is operated in response to the power control signal so as to continually reduce the error signal and thus provide the desired pressure value to the input port of the directional control valve.

Because of its inherently failsafe operational characteristics under all operating conditions, and further because of its improved steering feel whenever negligible power assist is required such as during on-center operation or at very high vehicular speeds, the hydro-mechanically coupled EPS systems of the present invention posses distinct advantages over all known prior art EPS systems.

### BRIEF DESCRIPTION OF THE DRAWINGS

Other advantages of the present invention can be understood by reference to the following detailed description when considered in connection with the accompanying drawings wherein:

FIG. 1 is a schematic view representative of a first inherently failsafe hydro-mechanically coupled EPS system of the present invention;

FIG. 2 is a schematic view representative of a second inherently failsafe hydro-mechanically coupled EPS system of the present invention;

FIG. 3 is a sectional view of a directional control under-lapped four-way valve utilized in the inherently failsafe hydro-mechanically coupled EPS systems of the present invention;

FIG. 4 is a flow chart depicting a method for enabling the first hydro-mechanically coupled power steering system of the present invention to function in the manner of an inherently failsafe EPS system; and

FIG. 5 is a flow chart depicting a method for enabling the second hydro-mechanically coupled power steering system of the present invention to function in the manner of an inherently failsafe EPS system.

### DETAILED DESCRIPTION OF THE PREFERRED EMBODIMENTS

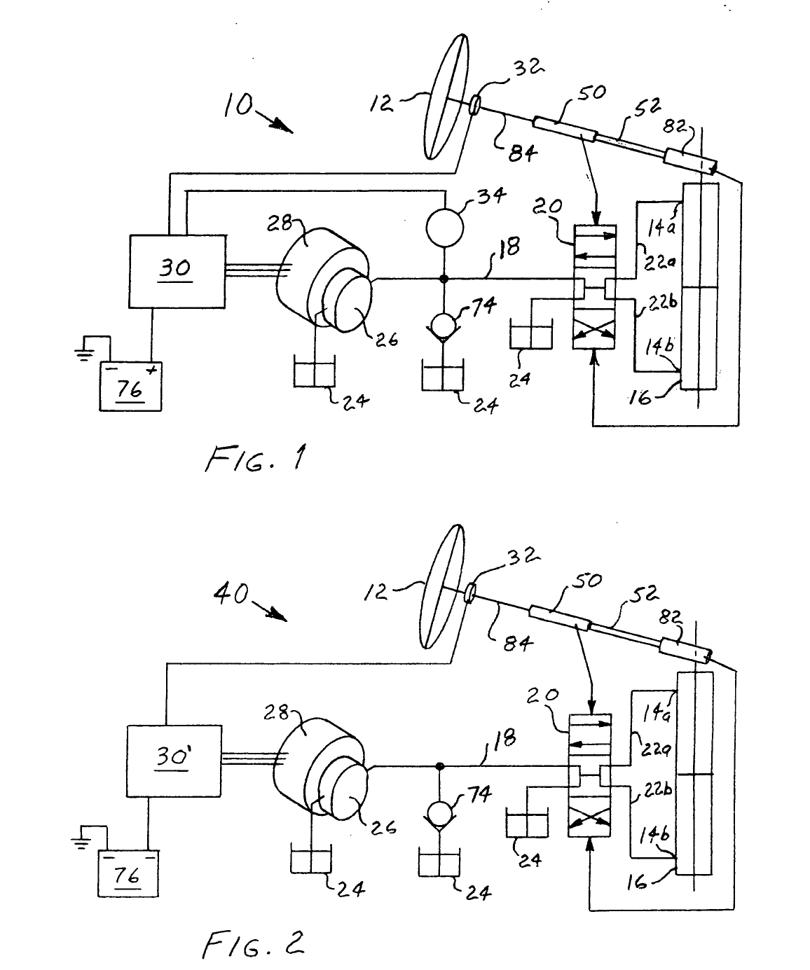

With reference first to FIG. 1, there shown is an inherently failsafe hydro-mechanically coupled EPS system 10 according to the present invention that is generically related to and controlled in a similar manner as the EPS system with hydraulic transmission (10) described in detail in the incorporated '254 patent. In the inherently failsafe hydro-mechanically coupled EPS system 10 however, pressurized fluid is provided to a directional control valve 20 in response to torque applied by a driver to a steering wheel 12. The directional control valve 20 may be an under-lapped four-way valve. When torque is applied in sufficient amount to effect translation through and beyond the underlap region of the directional control valve 20, the pressurized fluid is conveyed to or from one of left and right ports 14a and 14b of a double-acting power cylinder 16 via a fluid line 18, the directional control valve 20, and one of respective left and right turn lines 22a and 22b. Low pressure (hereinafter “reservoir pressure”) fluid is conveyed from or to the other one of the left and right ports 14a and 14b via the other one of the left and right turn lines 22a and 22b, the directional control valve 20 and on to a reservoir 24. In order to maintain the pressurized fluid conveyed to or from the directional control valve 20 at selected pressure levels, a positive displacement pump 26 is selectively driven by a motor 28 in response to a power control signal V_{c} issuing from a controller 30 from energy supplied from a battery 76. The inherently failsafe hydro-mechanically coupled EPS system 10 can be said to be a regenerative system in that the pump 26 both acts as a pump when delivering pressurized fluid to the fluid line 18, and as a hydraulic motor back driving the motor 28 that then in turn returns electrical energy to the controller 30 and battery 76. To clarify the presentation of the various connections to the reservoir 24, the reservoir 24 is shown in FIG. 1 at a plurality of locations that all constitute the same reservoir 24, not separate reservoirs.

Operationally, whenever torque is applied to the steering wheel 12, and particularly whenever that applied torque is sufficient to effect translation through and beyond the underlap region of the directional control valve 20, an applied torque signal Vₐₜ is sent to the controller 30 by a torque transducer 32 operatively connected thereto via steering shaft 84. Then the absolute value of the applied torque signal Vₐₜ is multiplied by a control function constant K_{cf} to form a control function signal V_{cf}, where the control function constant K_{cf} is generated by the controller 30 as a function of at least the applied torque value, and most probably vehicular speed, in accordance with procedures fully explained in the incorporated '254 patent. A pressure signal Vₚ from a pressure transducer 34 provided for measuring pressure values in the fluid line 18 is then subtracted from the control function signal V_{cf} whereby the resulting algebraic sum forms an error signal Vₑ. The error signal Vₑ is then filtered and amplified to form a power control signal V_{c} that is then continuously applied to the motor 28 in such a manner as to cause the error signal Vₑ to decrease in value.

Economically viable candidate pressure transducers (e.g., practical pressure transducers for utilization as the pressure transducer 34) are generally subject to temperature drift. Thus it is desirable to provide a method for automatically calibrating the pressure transducer 34 immediately before and during operation of the inherently failsafe hydro-mechanically coupled EPS system 10, wherein in this case calibration is defined as resetting the pressure signal Vₚ to a zero value whenever it can be assured that fluid pressure in the fluid line 18 has a value equal to reservoir pressure. Obviously, this is true immediately before operation of the host vehicle. Thus, the turn-on sequence for the inherently failsafe hydro-mechanically coupled EPS system 10 comprises first “waking up” the controller 30, then calibrating the pressure signal Vₚ to a zero value, and finally operationally activating the inherently failsafe hydro-mechanically coupled EPS system 10. During operation, calibration to a zero value is accomplished whenever the pressure signal Vₚ value achieves a minimum value as defined by its time-based differential concomitantly achieving a zero value.

In any case, the inherently failsafe hydro-mechanically coupled EPS system 10 of the present invention (e.g., along with the EPS system with hydraulic transmission (10) described in detail in the incorporated '254 patent) provides steering accuracy and stability unmatched by any other known power steering system because its operation is controlled in an internal feedback loop in accordance with the above described method of causing the error signal Vₑ to continually decrease in value. This is especially so when performance of the inherently failsafe hydro-mechanically coupled EPS system 10 is compared to that of typical mechanically coupled EOS systems. This especially favorable comparison is due to Coulomb friction that is typical in their drive gear trains.

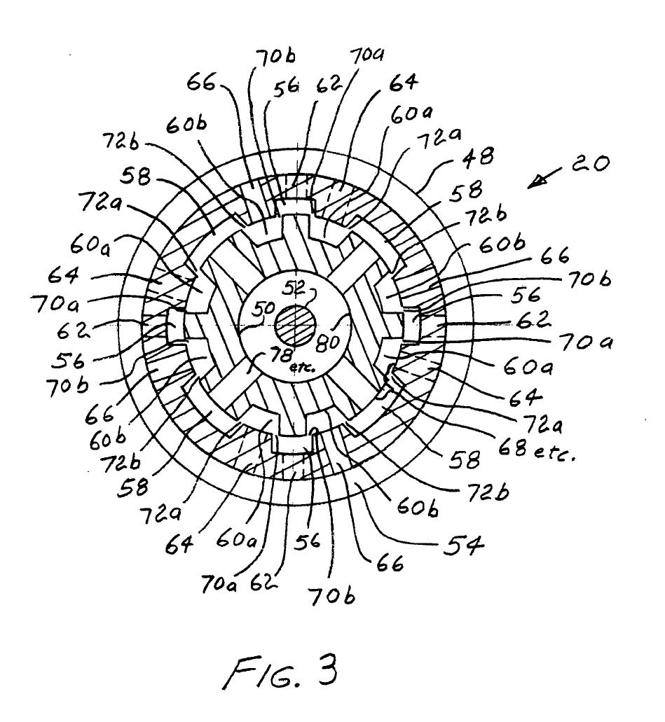

With reference now to FIG. 2, there shown is an inherently failsafe hydro-mechanically coupled EPS system 40 that is configured similarly to the hydro-mechanically coupled EPS system 10, but in a lower cost manner as achieved through elimination of the pressure transducer 34 and directly related elements of an otherwise identical controller 30′. In this case, the controller 30′ provides a power control signal V_{c} to the motor driven pump 28 at values determined directly from the control function signal V_{cf}, which could, for instance, be a linearly related flow of current to a motor having a fixed field (i.e., such as a brushless DC motor). Although steering performance of an inherently failsafe hydro-mechanically coupled EPS system 40 would admittedly be inferior to that of the inherently failsafe hydro-mechanically coupled EPS system 10, it is still equal to that of any other known power steering system (e.g., other than the EPS system with hydraulic transmission (10) described in the incorporated '254 patent) and almost certainly superior to that of typical mechanically coupled EPS systems because of the Coulomb friction typically found in their drive gear trains.

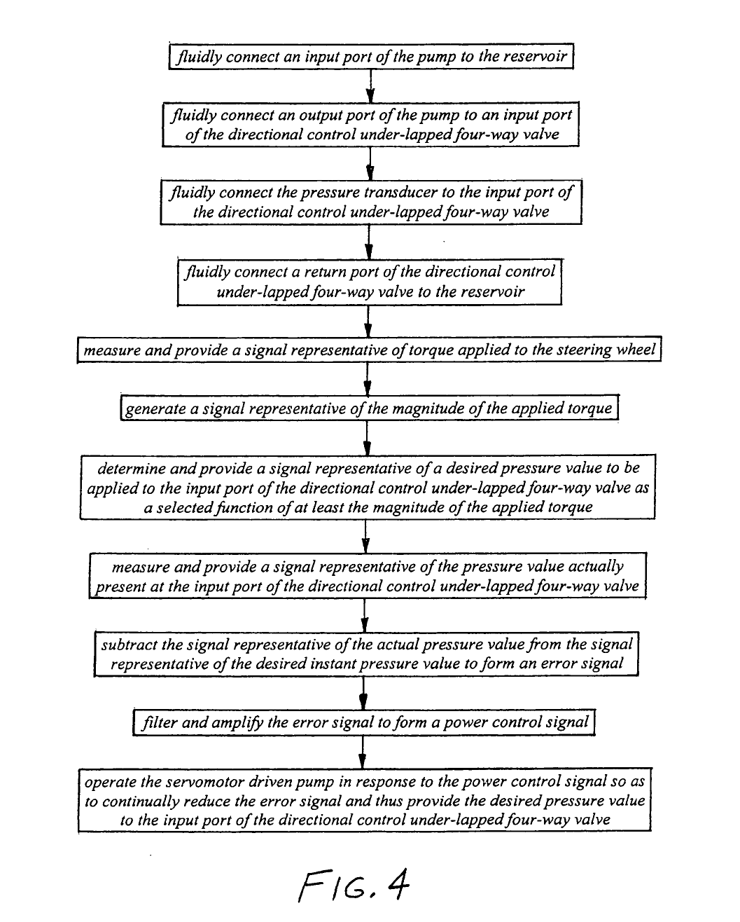

With additional reference now to FIG. 3, the directional control valve 20 is there shown as an underlapped four-way valve in a centered position within its underlap region. The directional control valve 20 comprises a valve sleeve 48 and an input shaft 50 compliantly affixed one to another in a normal manner via a torsion bar 52, wherein one end of the torsion bar 52 is affixed to a pinion 82 and the other end is affixed to the input shaft 50. As a design choice, either one of the valve sleeve 48 and input shaft 50 comprises multiple input and return slots 56 and 58 while the other one of the valve sleeve 48 and input shaft 50 comprises multiple left and right output slots 60a and 60b. (i.e., as depicted in FIG. 3, the valve sleeve 48 comprises the input and return slots 56 and 58 while the input shaft 50 comprises the output slots 60a and 60b.) In addition, input holes 62, left output holes 64 and right output holes 66 are formed in the valve sleeve 48 for respectively conveying fluid to or from circumferential grooves 54 formed in the periphery of the valve sleeve 48 and thence through ports of a valve housing (neither shown) to the fluid line 18, and left and right turn lines 22a and 22b. Return holes 78 are formed into a bore 80 of the input shaft 50 and from there are fluidly connected to the reservoir 24 via a housing port and return line (neither shown).

The directional control valve 20 is formed in an underlapped manner as a consequence of the input and return slots 56 and 58, and left and right output slots 60a and 60b all being formed with greater circumferential widths than juxtaposed lands 68 whereby input orifices 70a and 70b, and return orifices 72a and 72b are all enabled for freely conveying fluid in the on-center position as illustrated in FIG. 3. In general, the various slots are configured such that either set of input orifices 70a and return orifices 72b, or input orifices 70b and return orifices 72a close simultaneously and thus effect transition through their underlap region at suitably low values of applied torque. By way of example, if the torsion bar 52 has a torsional stiffness of 400 in.lbs./rad., the input shaft 50 has a radius of 0.400 in., and the orifice closing torque value is chosen to be 10 in.lbs.; then the resulting on-center circumferential width of the orifices 70a, 70b, 72a and 72b is 0.010 in. As a design choice, it may be desirable to configure the left and right output slots 60a and 60b in either a circumferentially angled or tapered manner as both shown in U.S. Pat. No. 5,353,593 entitled “Bootstrap Hydraulic Systems,” in order to effect a smooth transition to power assisted steering. Further, it is desirable for the control function constant K_{cf} generated by the controller 30 to have a zero value below similar low initiating values of applied torque (e.g., the ±10 in.lbs. value) and then blend into a selected linear control characteristic over perhaps that range again in order to effect a preferred on-center steering characteristic.

It is desirable for working pressures in the double-acting power cylinder 16 to always be kept at the lowest pressure values possible. This keeps pressure values applied to various power cylinder seals to a minimum thereby reducing leakage problems and minimizing Coulomb friction. The directional control valve 20 automatically accomplishes this task of course because at least one set of the left and right output slots 60a and 60b is always fluidly connected to the return slots 58 and thus the reservoir 24.

In addition, it is also desirable to fluidly couple both of the left and right output slots 60a and 60b (and thus the left and right cylinder ports 14a and 14b) to the reservoir 24 during “on-center” steering conditions. This precludes a possible problem wherein foam could form in the fluid due to rapid cycling of the steering wheel 12. This problem could arise due to pressure drop within either side of the double-acting power cylinder 16 relative to reservoir pressure. Such pressure drop could result from backflow through a respective one of the return orifices 72a and 72b of the directional control valve 20 when rapidly recovering from a turn. A practical solution is to provide a check valve 74 fluidly connected between the reservoir 24 and the fluid line 18 as shown in both of FIGS. 1 and 2.

In the event of any system failure, a primary failsafe shutdown procedure is implemented via the controller 30 precluding current from being applied to the motor 28 whereby manual steering is imposed regardless of steering load. Thus for applied torque values resulting in transition through and beyond the directional control valve 20's underlap region, fluid would enter fluid line 18 through the check valve 74 and then flow through the directional control valve 20 and power cylinder 16 in the manner already described. In addition however, a redundant failsafe feature is provided via the directional control valve 20 directly controlling fluid flow to the ports 14a and 14b of the double-acting power cylinder 16 in the manner of present engine pump driven hydraulic power steering systems wherein directional control of pressurized fluid applied to the double-acting power cylinder 16 is manually implemented by driver control of the directional control valve 20 via the steering wheel 12 and the steering shaft 84.

Admittedly the resulting steering feel would be rather “light” during such an emergency event. For instance, starting with the above example where the on-center circumferential width of the orifices 70a, 70b, 72a and 72b is 0.010 in. along with an orifice flow equation presented in a book by Herbert E. Merritt entitled “Hydraulic Control Systems” and published by John Wiley & Sons, Inc. of New York, the amount of circumferential closure of either set of orifices 70a and 72b or 70b and 72a required to effect a nominal differential power cylinder pressure of say 100 lbs./in.² is determined by the following equation:
x=0.010−(Q/2)/(70 w Sqrt[deltaP])=0.009 in.

wherein the following assumptions have been made: x is the amount of circumferential closure, Q is the pump flow rate=6 Liters/min., w is the combined axial length of any of the orifices 70a, 70b, 72a or 72b=4 in., and deltaP is pressure drop through either of the closing orifices=100 lbs./in.². Then again following above example, the resulting applied torque value is 9 in.lbs. The resulting steering feel would indeed be “light,” but it is certainly preferable to experiencing a runaway steering event that is theoretically possible with other known EPS system wherein a motor is directly linked to the dirigible wheels and thus that EPS system is absolutely dependent upon software controlled and electronically enabled failsafe apparatus and procedures for an orderly absolute failsafe shutdown. Thus both of the inherently failsafe hydro-mechanically coupled EPS systems 10 and 40 can indeed uniquely be said to be inherently failsafe EPS systems.

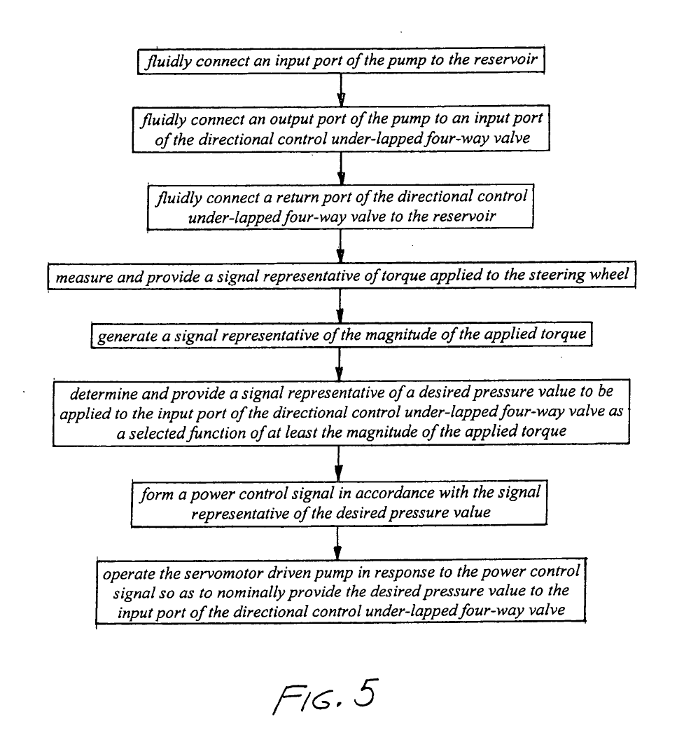

As depicted in the flow chart of FIG. 4, the present invention includes a method for enabling a hydro-mechanically coupled power steering system comprising a steering wheel; a reservoir; a power steering gear having a double-acting power cylinder and a directional control under-lapped four-way valve with output ports thereof operatively connected to the double-acting power cylinder; a motor driven pump; a pressure transducer; a steering wheel torque transducer; and a controller, to function in the manner of an inherently failsafe EPS system, wherein the method comprises the steps of: fluidly connecting an input port of the pump to the reservoir; fluidly connecting an output port of the pump to an input port of the directional control under-lapped four-way valve; fluidly connecting the pressure transducer to the input port of the directional control under-lapped four-way valve; fluidly connecting a return port of the directional control under-lapped four-way valve to the reservoir; measuring and providing a signal representative of torque applied to the steering wheel; generating a signal representative of the magnitude of the applied torque; determining and providing a signal representative of a desired pressure value to be applied to the input port of the directional control under-lapped four-way valve as a selected function of at least the magnitude of the applied torque; measuring and providing a signal representative of the pressure value actually present at the input port of the directional control under-lapped four-way valve; subtracting the signal representative of the actual pressure value from the signal representative of the desired instant pressure value to form an error signal; filtering and amplifying the error signal to form a power control signal; and operating the motor driven pump in response to the power control signal so as to continually reduce the error signal and thus provide the desired pressure value to the input port of the directional control under-lapped four-way valve.

Finally, as depicted in the flow chart of FIG. 5, the present invention also includes a method for enabling a hydro-mechanically coupled power steering system comprising a steering wheel; a reservoir; a power steering gear having a double-acting power cylinder and a directional control under-lapped four-way valve with output ports thereof operatively connected to the double-acting power cylinder; a motor driven pump; a steering wheel torque transducer; and a controller, to function in the manner of an inherently failsafe EPS system, wherein the method comprises the steps of fluidly connecting an input port of the pump to the reservoir; fluidly connecting an output port of the pump to an input port of the directional control under-lapped four-way valve; fluidly connecting a return port of the directional control underlapped four-way valve to the reservoir; measuring and providing a signal representative of torque applied to the steering wheel; generating a signal representative of the magnitude of the applied torque; determining and providing a signal representative of a desired pressure value to be applied to the input port of the directional control under-lapped four-way valve as a selected function of at least the magnitude of the applied torque; forming a power control signal in accordance with the signal representative of the desired pressure value; and operating the motor driven pump in response to the power control signal so as to nominally provide the desired pressure value to the input port of the directional control under-lapped four-way valve.

Having described the invention, however, many modifications thereto will become immediately apparent to those skilled in the art to which it pertains, without deviation from the spirit of the invention. For instance, it would be possible to configure either of the hydro-mechanically coupled EPS systems without the check valve 74. Or an additional failsafe feature could be provided in the form of a normally open, solenoid-controlled two-way valve fluidly connecting the fluid line 18 to the reservoir 24 unless its solenoid was activated. Such modifications clearly fall within the scope of the invention.

The instant systems are capable of providing inherently failsafe and otherwise improved power steering systems intended for small through medium sized vehicles, and accordingly find industrial application both in America and abroad in power steering systems intended for such vehicles and other devices requiring powered assist in response to torque applied to a steering wheel, or indeed, any control element functionally similar in nature to a steering wheel.

What is claimed is:

1. A hydro-mechanically coupled EPS system for a vehicle comprising:
at least one power cylinder;
a directional control valve operatively connected to the at least one power cylinder and having a first output port and a second output port for controlling a steering direction;
a pump having an output port fluidly connected to an input port of the directional control valve; and
a controller controlling the pump based upon a steering wheel input signal.

2. The system of claim 1 wherein the directional control valve is controlled by a steering wheel mechanically coupled to the directional control valve.

3. The system of claim 2 wherein the directional control valve is a four-way valve.

4. The system of claim 3 further including a reservoir, the pump having an input fluidly connected to the reservoir.

5. The system of claim 2 further including a pressure transducer for providing a pressure signal indicative of pressure values present at the input port of the directional control valve.

6. The system of claim 5 wherein the controller controls the pump based upon the pressure signal from the pressure transducer.

7. The system of claim 2 further including a torque sensor generating an applied torque signal indicative of torque applied to the steering wheel and wherein the controller controls the pump based upon the applied torque signal.

8. The system of claim 1 wherein the directional control valve is an underlapped four-way valve.

9. The system of claim 8 wherein the at least one power cylinder is a double-acting power cylinder having a left input port and a right input port, the first output port and the second output port of the directional control valve fluidly coupled to the left input port and the right input port, respectively.

10. A method for operating a power steering system comprising
a) measuring applied torque on a steering wheel;
b) determining a desired pressure value to be applied to an input port of a directional control valve as a function of the applied torque;
c) measuring an actual pressure value present at the input port of the directional control valve;
d) comparing the actual pressure value to the desired pressure value;
e) controlling a pump supplying fluid to the input port of the directional control valve based upon said step d) in order to provide the desired pressure value to the input port of the directional control valve.

11. The method of claim 10 further including the step of:
f) operating the directional control valve to supply the fluid from the input port of the directional control valve alternately to a left input port to steer the vehicle left and a right input port to steer the vehicle right.

12. The method of claim 11 wherein said step f) is performed by turning a steering wheel mechanically coupled to the directional control valve.

13. The method of claim 12 wherein the left input port and the right input port are input ports to a double-acting power cylinder.

14. A power steering system for a vehicle comprising:
a pump;
a steering wheel;
a four-way valve for controlling a steering direction, the four-way valve mechanically coupled to the steering wheel, the four-way valve selectively fluidly connecting an input port to a left output port or a right output port for controlling steering direction; and
a controller controlling the pump to control an amount of power steering assist.

15. The system of claim 14 further including a reservoir, the pump including a return port fluidly connected to the reservoir.

16. The system of claim 14 further including a pressure transducer for providing a pressure signal indicative of pressure values present at an input port of the four-way valve.

17. The system of claim 16 wherein the controller controls the pump based upon a comparison of a control function signal and the pressure signal issued by the pressure transducer.

18. The system of claim 17 wherein the four-way valve is an underlapped valve.
